(19) United States
(12) Patent Application Publication
(10) Pub. No.: US 2025/0247505 A1
(43) Pub. Date: Jul. 31, 2025

(54) IMAGE PROCESSING SYSTEM AND IMAGE PROCESSING METHOD

(71) Applicant: MEDIATEK INC., Hsin-Chu (TW)

(72) Inventor: Chun-Wei Chen, Hsinchu City (TW)

(73) Assignee: MEDIATEK INC., Hsin-Chu (TW)

(21) Appl. No.: 18/424,849

(22) Filed: Jan. 28, 2024

(51) Int. Cl. H04N 7/18; H04N 5/265; H04N 23/45

(52) U.S. Cl. CPC H04N 7/188; H04N 5/265; H04N 23/45

(57) ABSTRACT

An image processing system, comprising: a visible light sensor, configured to generate visible light sensing signals; a visible light ISP (image signal processor), configured to generate visible light images according to the visible light sensing signals; an invisible light sensor, configured to generate invisible light sensing signals; an invisible light ISP, configured to generate invisible light images according to the invisible light sensing signals; and an event detector, configured to activate or inactivate the invisible light ISP according to if a specific event occurs. The image processing system may be applied to a surveillance system.

### BACKGROUND

A related surveillance system comprises an image sensor for sensing images, thereby a danger event can be detected according to the sensing images. However, the image sensor in the surveillance system is always a visible light sensor which can only sense visible light, thus some danger events which emit invisible light, such as an arc or a high temperature, is hard to be detected.

### SUMMARY

One objective of the present application is to provide an image processing system which can detect a danger event which cannot be found according to visible light images.

Another objective of the present application is to provide an image processing method which can detect a danger event which cannot be found according to visible light images.

One embodiment of the present application is to provide an image processing system, comprising: a visible light sensor, configured to generate visible light sensing signals; a visible light ISP (image signal processor), configured to generate visible light images according to the visible light sensing signals; an invisible light sensor, configured to generate invisible light sensing signals; an invisible light ISP, configured to generate invisible light images according to the invisible light sensing signals; and an event detector, configured to activate or inactivate the invisible light ISP according to if a specific event occurs.

Another embodiment of the present application is to provide an image processing method, applied to an image processing system comprising a visible light sensor, a visible light ISP, an invisible light sensor, and an visible light ISP, comprising: (a) generating visible light sensing signals by the visible light sensor; (b) generating visible light images according to the visible light sensing signals by the visible light ISP (image signal processor); (c) generating invisible light sensing signals by the invisible light sensor; (d) activating or inactivating the invisible light ISP according to if a specific event occurs, wherein the invisible light ISP is configured to generate invisible light images according to the invisible light sensing signals.

The above-mentioned image processing system and image processing method may be applied to a surveillance system.

In view of above-mentioned embodiment, the danger event which cannot be found according to visible light images can be detected. Further, the components for generating invisible light images or combination images comprising the invisible light images may be inactivated if no danger event occurs. By this way, the power consumption of the whole system may be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image processing system according to one embodiment of the present application.

FIG. 2 is a schematic diagram illustrating an invisible light image with an image of an arc, according to one embodiment of the present application.

FIG. 3, FIG. 4 and FIG. 5 are block diagrams illustrating image processing systems according to different embodiments of the present application.

FIG. 6 is a schematic diagram illustrating the power consumptions rates of the image processing systems illustrated in FIG. 1-FIG. 5, according to one embodiment of the present application.

FIG. 7 is a block diagram illustrating a surveillance system according to one embodiment of the present application.

FIG. 8 is a flow chart illustrating an image processing method according to one embodiment of the present application.

### DETAILED DESCRIPTION

Several embodiments are provided in following descriptions to explain the concept of the present invention. The method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

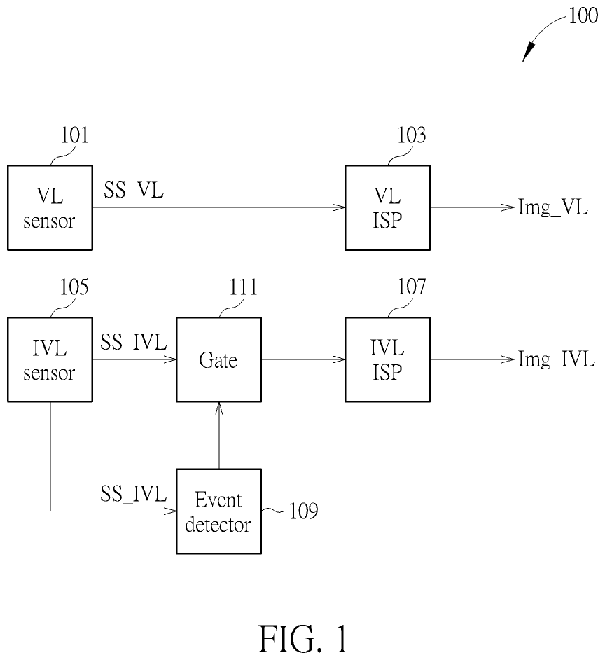

FIG. 1 is a block diagram illustrating an image processing system 100 according to one embodiment of the present application. As shown in FIG. 1, the image processing system 100 comprises a visible light sensor 101, a visible light ISP (image signal processor) 103, an invisible light sensor 105, an invisible light ISP 107 and an event detector 109. The visible light sensor 101 is configured to generate visible light sensing signals SS_VL. For example, the visible light sensor 101 comprises a plurality of pixel circuits which generate charges as visible light sensing signals SS_VL responding to received visible light. The visible light ISP 103 is configured to generate visible light images Img_VL according to the visible light sensing signals SS_VL.

The invisible light sensor 105 is configured to generate invisible light sensing signals SS_IVL. For example, the invisible light sensor 105 comprises a plurality of pixel circuits which generate charges as invisible light sensing signals SS_IVL responding to received invisible light. In one embodiment, the invisible light sensor 105 is configured to sense UV light, NIR light or thermal light (LWIR light), but not limited. The invisible light ISP 107 is configured to generate invisible light images Img_IVL according to the invisible light sensing signals SS_IVL. The event detector 109 is configured to activate or inactivate the invisible light ISP 107 according to if a specific event is detected. The event detector 109 may comprise various circuits, such as a processing circuit or logic gates, to perform the function thereof.

In the embodiment of FIG. 1, the image processing system 100 further comprises a gate 111, which may be but is not limited to be implemented by at least one logic gate. In such case, the event detector 109 is configured to turn on or turn off the gate 111. If the gate 111 turns on, the invisible light sensing signals SS_IVL are transmitted to the invisible light ISP 107 such that the invisible light ISP 107 is activated. On the contrary, if the gate 111 turns off, the invisible light sensing signals SS_IVL are not transmitted to the invisible light ISP 107 such that the invisible light ISP 107 is inactivated. However, the gate 111 may be removed in other embodiments, and the invisible light ISP 107 may be activated or inactivated by other mechanisms.

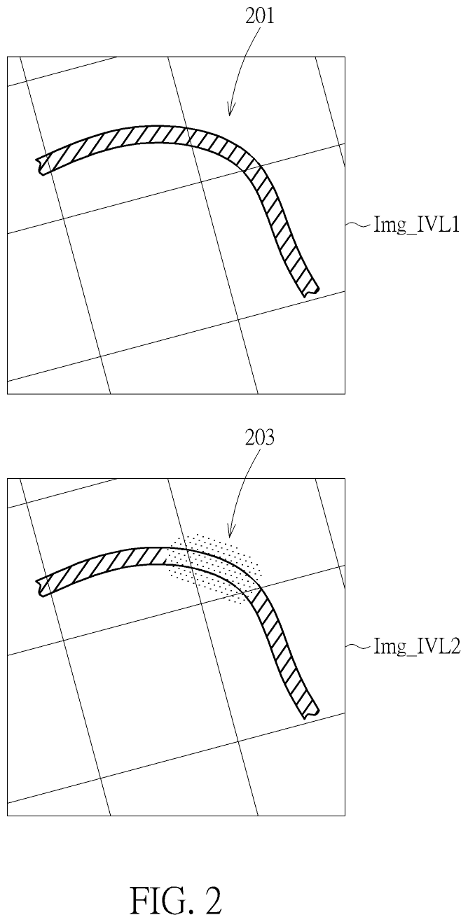

In one embodiment, the specific event is that the invisible light sensing signals SS_IVL meet a specific rule. For example, the specific rule is that variation of the invisible light sensing signals SS_VL is over a variation threshold. For more detail, if a danger event which generates invisible light occurs, two or more continuous invisible light images Img_IVL may have different image contents. FIG. 2 is a schematic diagram illustrating an invisible light image with an arc. In the invisible light image Img_IVL1, the wire 201 operates normally. However, in the invisible light image Img_IVL2 following the invisible light image Img_IVL1, an arc 203 occurs, thus the invisible light sensor 105 may sense the UV light generated by the arc 203. Accordingly, the continuous invisible light images Img_IVL1 and Img_IVL2 have different image contents, which mean a large variation exists between invisible light sensing signals SS_IVL thereof. Thus, if a variation of the invisible light sensing signals SS_IVL is over a variation threshold, it may mean that a danger event occurs.

In another embodiment, the specific rule is that pixel value distributions of the invisible light sensing signals SS_IVL meet a predetermined distribution. As described in the example of FIG. 2, the invisible light sensor 105 may sense the UV light generated by the arc 203 in the invisible light image Img_IVL2, and pixel values of the UV light may meet the predetermined distribution which may be recorded in the event detector 109. Therefore, if the pixel value distributions of the invisible light sensing signals SS_IVL meet a predetermined distribution, it may mean that a danger event occurs. Please note, the arc 203 is used as an example for explaining in FIG. 2. However, the concepts provided by the present application can be applied to any other danger event which generates invisible light.

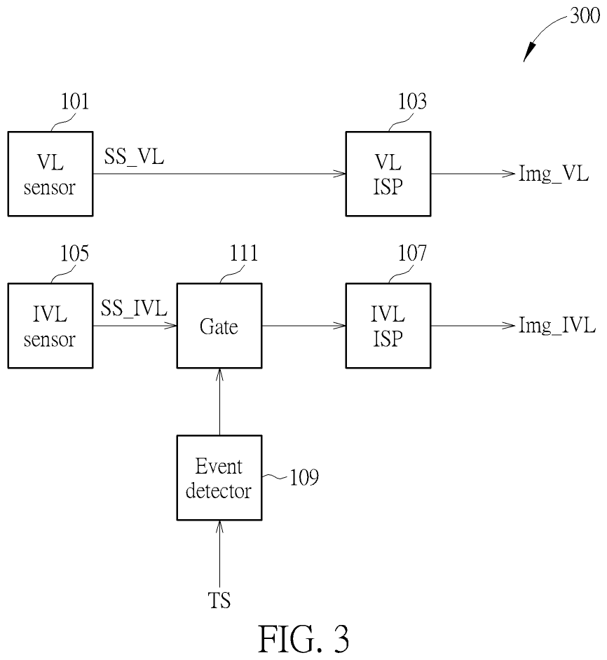

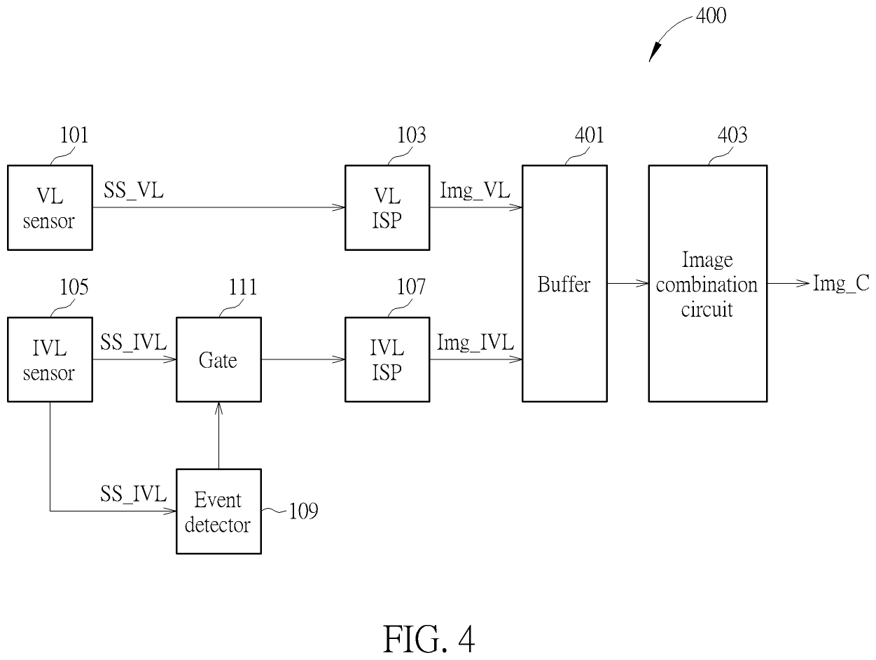

FIG. 3 is a block diagram illustrating an image processing system, according to another embodiment of the present application. In the embodiment of FIG. 3, the components of the image processing system 300 are the same as which of the image processing system 100 in FIG. 4, but the specific event is a trigger signal TS for triggering the event detector 109 to activate the invisible light ISP 107. The trigger signal TS may be generated by various methods. In one embodiment, the trigger signal TS is generated by a thermal sensor. For example, if the thermal sensor senses that a temperature of a device or a portion of the building is over a temperature threshold, it can send the trigger signal TS to activate the invisible light ISP 107, such that a fire which cannot be found in visible light images Img_VL may be checked or confirmed again according to the invisible light images Img_IVL.

In another embodiment, the trigger signal TS is generated by a smoke detector. Similarly, if the smoke detector detects smoke, it can send the trigger signal TS to activate the invisible light ISP 107, such that a fire which cannot be found in visible light images Img_VL may be checked or confirmed again according to the invisible light images Img_IVL. The trigger signal TS may be generated by other methods besides the thermal sensor and the smoke detector. For example, the trigger signal TS may be generated by a voltage detector or be generated manually.

In the embodiments of FIG. 1 and FIG. 3, the visible light ISP 103 may also operate corresponding to the specific event. In one embodiment, the visible light ISP 103 is activated and the invisible light ISP 107 is inactivated if the specific event is not detected, and the visible light ISP 103 is inactivated and the invisible light ISP 107 is activated if the specific event occurs. By this way, the power consumption of the image processing system 100 may be saved. However, in another embodiment, the visible light ISP 103 may always keep as active to generate visible light images Img_VL.

The image processing system provided by the present application may have other structures. FIG. 4 is a block diagram illustrating an image processing system 400 according to one embodiment of the present application. As shown in FIG. 4, the image processing system 400 comprises a visible light sensor 101, a visible light ISP 103, an invisible light sensor 105, an invisible light ISP 107, an event detector 109, a buffer 401 and an image combination circuit 403.

The visible light sensor 101 is configured to generate visible light sensing signals SS_VL. The visible light ISP 103 is configured to generate visible light images Img_VL according to the visible light sensing signals SS_VL. The invisible light sensor 105 is configured to generate invisible light sensing signals SS_IVL. In one embodiment, the invisible light sensor 105 is configured to sense UV light, NIR light or thermal light (LWIR light), but not limited. The invisible light ISP 107 is configured to generate invisible light images Img_IVL according to the invisible light sensing signals SS_IVL. The event detector 109 is configured to activate or inactivate the invisible light ISP 107 according to if a specific event occurs. The event detector 109 may comprise various circuits, such as a processing circuit or logic gates, to perform the function thereof.

In the embodiment of FIG. 4, the image processing system 100 further comprises a gate 111, which may be but is not limited to be implemented by at least one logic gate. In such case, the event detector 109 is configured to turn on or turn off the gate 111. If the gate 111 turns on, the invisible light sensing signals SS_IVL are transmitted to the invisible light ISP 107 such that the invisible light ISP 107 is activated. On the contrary, if the gate 111 turns off, the invisible light sensing signals SS_IVL are not transmitted to the invisible light ISP 107 such that the invisible light ISP 107 is inactivated. However, the gate 111 may be removed in other embodiments, and the invisible light ISP 107 may be activated/inactivated by other mechanisms.

The image combination circuit 403, such as a GPU (Graphics Processing Unit), is configured to combine the visible light images Img_VL and the invisible light images Img_IVL to generate combination images Img_C. For example, the image corresponding to the invisible light in the invisible light image Img_IVL may be combined to the visible light image Img_VL. In one embodiment, the event detector 109 is further configured to activate or inactivate the image combination circuit 403 according to if the specific event occurs. The buffer 401 is configured to buffer the visible light images Img_VL and the invisible light images Img_IVL for the combination thereof. However, if the visible light images Img_VL and the invisible light images Img_IVL are synchronized well, the buffer 401 may be removed.

In the embodiment of FIG. 4, the specific event is that the invisible light sensing signals SS_IVL meet a specific rule. As illustrated in above-mentioned descriptions, in one embodiment, the specific rule is that variation of the invisible light sensing signals SS_VL is over a variation threshold. Besides, in another embodiment, the specific rule is that pixel value distributions of the invisible light sensing signals SS_IVL meet a predetermined distribution.

FIG. 5 is a block diagram illustrating an image processing system, according to another embodiment of the present application. In the embodiment of FIG. 5, the components of the image processing system 500 are the same as which of the image processing system 400 in FIG. 4, but the specific event is a trigger signal TS for triggering the event detector TS to activate the invisible light ISP 107. The trigger signal TS may be generated by various methods. AS above-mentioned, in one embodiment, the trigger signal TS is generated by a thermal sensor. For example, if the thermal sensor senses that a temperature of a device or a portion of the building is over a temperature threshold, it can send the trigger signal TS to activate the invisible light ISP 107, such that a fire which cannot be found in visible light images Img_VL may be checked or confirmed again according to the invisible light images Img_IVL.

As above-mentioned, in another embodiment, the trigger signal TS is generated by a smoke detector. Similarly, if the smoke detector detects smoke, it can send the trigger signal TS to activate the invisible light ISP 107, such that a fire which cannot be found in visible light images Img_VL may be checked or confirmed again according to the invisible light images Img_IVL. The trigger signal TS may be generated by other methods besides the thermal sensor and the smoke detector. For example, the trigger signal TS may be generated by a voltage detector or be generated manually.

In the embodiments of FIG. 4 and FIG. 5, the visible light ISP 103 is activated both when the specific event occurs and when specific event does not occur. If the specific event does not occur, the invisible light ISP 107 is inactivated thus no invisible light images Img_IVL are generated. Accordingly, in such case, the combination images Img_C are not generated or only comprises the contents of the visible light images Img_VL. On the contrary, if the specific event occurs, the invisible light ISP 107 is activated to generate the invisible light images Img_IVL, thus the combination images Img_C comprises the contents of the visible light images Img_VL and contents of the invisible light images Img_IVL.

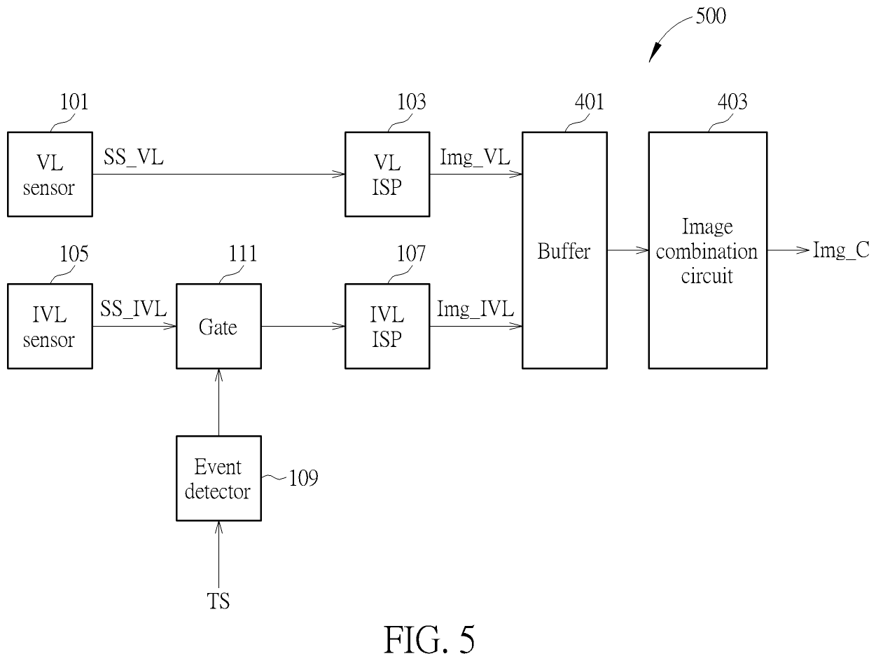

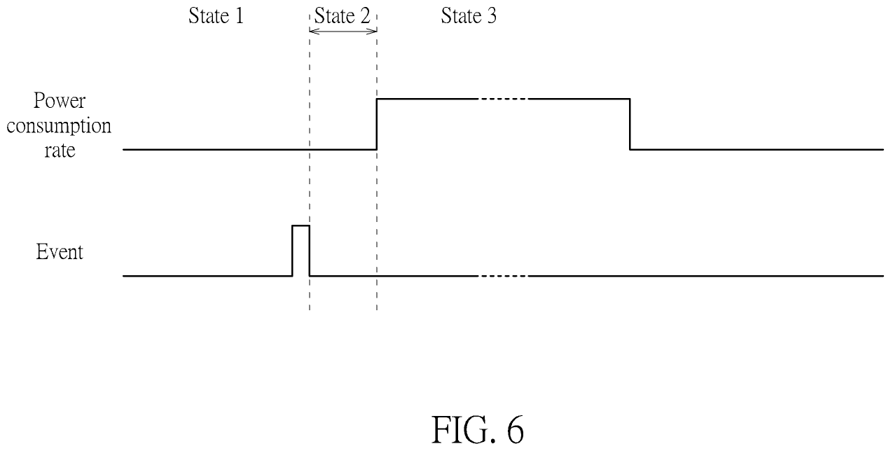

As above-mentioned, the invisible light ISP 107 and/or the image combination circuit 403 maybe inactivated when the specific even does not occur. Accordingly, the power consumption rates of the image processing system in different states may be different. FIG. 6 is a schematic diagram illustrating the power consumptions rates of the image processing systems illustrated in FIG. 1-FIG. 4. Please note, in the embodiment of FIG. 6, the visible light ISP may be activated in all states. As shown in FIG. 6, in the beginning of state 1, the specific event does not occur (the low logic level) and the invisible light ISP 103 and/or the image combination circuit 403 is inactivated, thus the power consumption rate of the image processing system is a lower first power consumption rate. At the end of state 1, the specific event occurs (the high logic level), thus the image processing system enters the state 2. In state 2, the invisible light ISP 103 and/or the image combination circuit 403 is switched from inactivated from activated. In state 3, the invisible light ISP 103 and/or the image combination circuit 403 is activated, thus the power consumption rate is increased to a higher second power consumption rate.

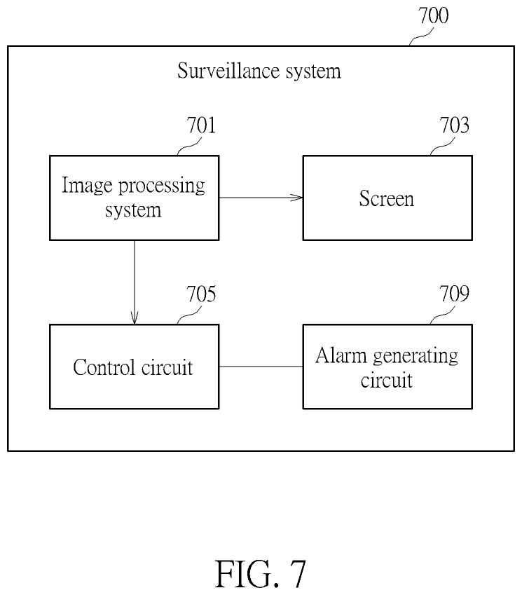

The image processing system provided by the present application may be applied to various applications. In one embodiment, the image processing system is applied to a surveillance system such as a surveillance camera. FIG. 7 is a block diagram illustrating a surveillance system 700 according to one embodiment of the present application. As illustrated in FIG. 7, the surveillance system 700 comprises an image processing system 701 and a screen 703. The image processing system 701 may comprise the structures illustrated in FIG. 1, FIG. 3, FIG. 4 and FIG. 5, and may output the above-mentioned visible light images Img_VL, the invisible light images Img_IVL or the combination images Img_C to the screen 703 for displaying. By this way, the user may monitoring the target to be monitored according to the visible light images Img_VL, the invisible light images Img_IVL or the combination images Img_C.

In one embodiment, the surveillance system 700 may further comprise a control circuit 705, which is configured to control the alarm generating circuit 709 to generate alarms according to the invisible light images Img_IVL or the combination images Img_C. The alarms may be, for example, sound alarms, light alarms, or messages which are transmitted to a mobile device of a user.

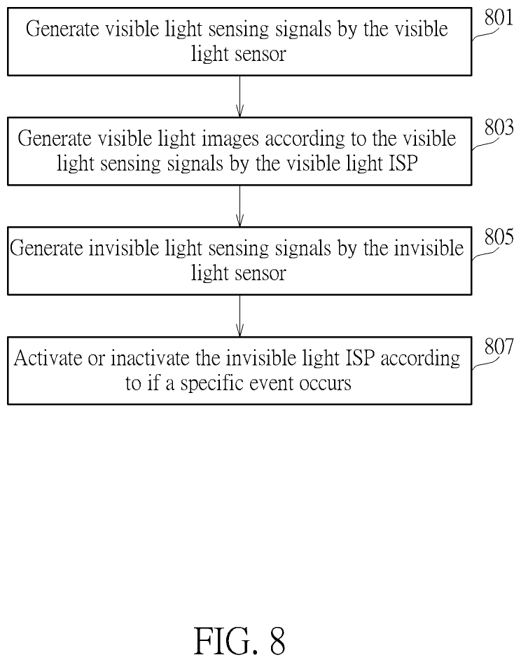

In view of above-mentioned embodiments, an image processing method may be acquired. FIG. 8 is a flow chart illustrating an image processing method according to one embodiment of the present application. The image processing method comprises following steps:

### Step 801

Generate visible light sensing signals by the visible light sensor (e.g., the visible light sensor 101).

### Step 803

Generate visible light images according to the visible light sensing signals by the visible light ISP (e.g., the visible light ISP 103).

### Step 805

Generate invisible light sensing signals by the invisible light sensor (e.g., the invisible light sensor 105).

### Step 807

Activate or inactivate the invisible light ISP (e.g., the invisible light ISP 107) according to if a specific event occurs.

The invisible light ISP is configured to generate invisible light images according to the invisible light sensing signals

In view of above-mentioned embodiment, the danger event which cannot be found according to visible light images can be detected. Further, the components for generating invisible light images or combination images comprising the invisible light images may be inactivated if no danger event occurs. By this way, the power consumption of the whole system may be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing system, comprising:
a visible light sensor, configured to generate visible light sensing signals;
a visible light ISP (image signal processor), configured to generate visible light images according to the visible light sensing signals;
an invisible light sensor, configured to generate invisible light sensing signals;
an invisible light ISP, configured to generate invisible light images according to the invisible light sensing signals; and
an event detector, configured to activate or inactivate the invisible light ISP according to if a specific event is detected by the event detector.

2. The image processing system of claim 1, wherein the specific event is that the invisible light sensing signals meet a specific rule.

3. The image processing system of claim 2, wherein the specific rule is that variation of the invisible light sensing signals is over a variation threshold.

4. The image processing system of claim 2, wherein the specific rule is that pixel value distributions of the invisible light sensing signals meet a predetermined distribution.

5. The image processing system of claim 1, wherein the specific event is a trigger signal for triggering the event detector to activate the invisible light ISP.

6. The image processing system of claim 5, wherein the trigger signal is from a thermal sensor or a smoke detector.

7. The image processing system of claim 6, wherein the event detector is triggered to allow the invisible light sensing signals to be transmitted to the invisible ISP.

8. The image processing system of claim 1, further comprising:
an image combination circuit, configured to combine the visible light images and the invisible light images to generate combination images;
wherein the event detector is further configured to activate or inactivate the image combination circuit according to if the specific event is detected.

9. The image processing system of claim 1, wherein the image processing system has a first power consumption rate when the specific event is not detected and has a second power consumption rate after the specific event is detected, wherein the second consumption rate is higher than the first consumption rate.

10. An image processing method, applied to an image processing system comprising a visible light sensor, a visible light ISP, an invisible light sensor, and an visible light ISP, comprising:
(a) generating visible light sensing signals by the visible light sensor;
(b) generating visible light images according to the visible light sensing signals by the visible light ISP (image signal processor);
(c) generating invisible light sensing signals by the invisible light sensor;
(d) activating or inactivating the invisible light ISP according to if a specific event is detected, wherein the invisible light ISP is configured to generate invisible light images according to the invisible light sensing signals.

11. The image processing method of claim 10, wherein the specific event is that the invisible light sensing signals meet a specific rule.

12. The image processing method of claim 11, wherein the specific rule is that variation of the invisible light sensing signals is over a variation threshold.

13. The image processing method of claim 11, wherein the specific rule is that pixel value distributions of the invisible light sensing signals meet a predetermined distribution.

14. The image processing method of claim 10, wherein the specific event is a trigger signal for triggering the event detector to activate the invisible light ISP.

15. The image processing method of claim 14, wherein the trigger signal is from a thermal sensor or a smoke detector.

16. The image processing method of claim 14, wherein event detector is triggered to allow the invisible light sensing signals to flow to the invisible ISP.

17. The image processing method of claim 10, further comprising:
combining the visible light images and the invisible light images to generate combination images;
wherein the step (d) further activates or inactivates the image combination circuit according to if the specific event is detected.

18. The image processing method of claim 10, wherein the image processing system has a first power consumption rate when the specific event does not occur and has a second power consumption rate after the specific event occurs, wherein the second consumption rate is higher than the first consumption rate.
